(19) United States
(12) Patent Application Publication
(10) Pub. No.: US 2006/0050724 A1
(43) Pub. Date: Mar. 9, 2006

(54) Interface for a network management system

(76) Inventors: Goncalo Pereira, Amadora (PT); Pedro Pessoa, Lisboa (PT)

Correspondence Address: SIEMENS CORPORATION;INTELLECTUAL PROPERTY DEPARTMENT, 170 WOOD AVENU, SOUTH, ISELIN, NJ, 08830, US

(21) Appl. No.: 11/217,647

(22) Filed: Sep. 1, 2005

(30) Foreign Application Priority Data
Sep. 7, 2004 (EP) 04255422.0

(51) Int. Cl. H04L 12/56; H04L 12/28

(52) U.S. Cl. 370/419

(57) ABSTRACT

An interface (3) includes a hash function (5) for storing fields of network element alarms which cannot be processed by a network management system (6) into fields that can be processed.

### CROSS REFERENCE TO RELATED APPLICATIONS

This application claims priority to the European application No. 04255422.0, filed Sep. 7, 2004 and which is incorporated by reference herein in its entirety.

### FIELD OF INVENTION

This invention relates to an interface for network management system, in a communications network.

### SUMMARY OF INVENTION

Communications networks are built from network elements. Examples of such elements include switches, multiplexers, modems or other basic units of a network.

The elements of the network may experience faults, high loading, low loading conditions which may require an intervention in the way the network is configured. For example, if a router develops a fault or is overloaded, traffic may be re-routed to avoid that router. In order to cater for this, network elements issue alarms to a network manager system (NMS).

The NMS is a computer implemented device which receives alarms and initiates remedial action such as re-configuring the network to re-route traffic.

The NMS are designed to operate within a standard and thus can cater only for a set of alarms with limited accompanying information of fixed length.

The network elements or an intermediary system called an Element Management System can produce alarms with more information than is permitted or acceptable to the NMS.

According to the invention there is provided an interface for a network management system to provide thereto compatible network element alarms which interface comprising an input for accepting incoming alarms generated by network elements and a hashing processor for applying a hash function to the incoming alarms to produce hashed alarms output to the network management system.

A hashing function in one which take an arbitrary amount of information and reduces it to a fixed number of bits. Thus, by use of the invention alarms generated by network elements having an arbitrary amount of information are converted into alarms of a fixed bit length conforming to the requirements of the network management system.

In the preferred embodiment the hashing function is one known as MD5.

A specific embodiment of the invention will now be described, by way of example only, with reference to the drawing in which:

### BRIEF DESCRIPTION OF THE DRAWINGS

FIG. 1 shows in schematic form an interface in accordance with the invention used in a communications network; and

FIG. 2 is an explanatory diagram.

### DETAILED DESCRIPTION OF THE INVENTION

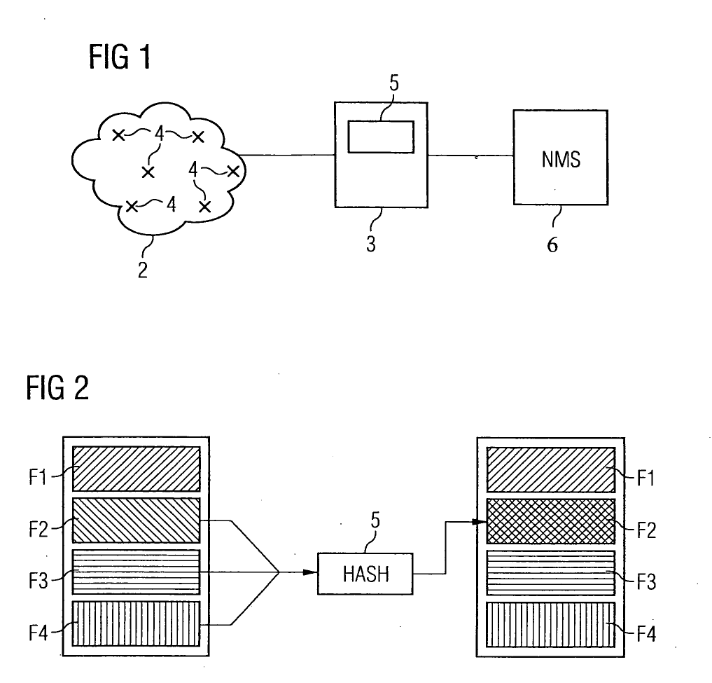

With reference to FIG. 1, a communications system comprises a network 2 including a large number of network elements 4. Alarms from the network elements 4 are coupled by an interface 3 to a network management system 6 (NMS).

The interface 3 is a suitably programmed computer including a hashing processor 5. The hashing processor 5 applies a hashing function to the incoming alarms. The hashed alarms are then output to the NMS 6.

The hashing function used is MD5.

The hashing function produces a digest from the incoming alarms of those fields of the alarm which cannot be directly processed by the NMS 4. This digest is input into a field which can be processed by the NMS 4. This is depicted in FIG. 2. It will be seen that the data in fields F1 to F4 is taken by the hash function and input into field F2 of the output alarm.

1. An interface for a network management system to provide compatible alarms thereto derived from alarms generated by network elements which interface comprising an input for accepting incoming alarms generated by network elements, a hashing processor for applying a hash function to the incoming alarms to produce hashed alarms and an output for coupling the hashed alarms to the network management system.

2. The interface as claimed in claim 1, wherein the hashing function is an MD5 function.

3. The interface as claimed in claim 1, wherein the interface is integrated in an communications system.

4. A communications system, comprising:
a network of network elements;
a network management system; and
an interface as claimed in claim 1.

5. The communications system as claimed in claim 4, wherein the hashing function is an MD5 function.

6. A method for providing compatible alarms for an interface of a network management system, comprising:
receiving alarms generated by network elements of a communications system to be monitored;
applying a hash function to the alarms to create hashed alarms by a hashing processor; and
transmitting the hashed alarms to the interface of a network management system.

7. The method as claimed in claim 6, wherein the hashing function is an MD5 function.

8. The method as claimed in claim 6, wherein the receiving alarms are derived from alarms generated by network elements.

9. A network element adapted to provide hashed alarms from alarms generated by the network element and/or further network elements to an interface, wherein a hash function is applied to the generated alarms to produce the hashed alarms.

10. The network element, as claimed in claim 9, wherein the hash function is applied by a hashing processor.

11. The network element, as claimed in claim 9, wherein the hashed alarms are compatible to the generated alarms.

12. The network element, as claimed in claim 9, wherein the interface coupled to a network management system.
